(19) United States
(12) Patent Application Publication
(10) Pub. No.: US 2021/0064990 A1
(43) Pub. Date: Mar. 4, 2021

(54) METHOD FOR MACHINE LEARNING DEPLOYMENT

(71) Applicant: United Smart Electronics Corporation, Tainan City (TW)

(72) Inventors: Chih-Wei HSU, Tainan City (TW); Jia-Ying LI, Tainan City (TW); Chi LI, Tainan City (TW); Ci-Ruei JIANG, Tainan City (TW)

(21) Appl. No.: 16/751,394

(22) Filed: Jan. 24, 2020

(30) Foreign Application Priority Data
Aug. 27, 2019 (TW) 108130654

(51) Int. Cl. G06N 3/08; G06N 3/10

(52) U.S. Cl. CPC G06N 3/08; G06N 3/105

(57) ABSTRACT

A method for machine learning deployment that comprises steps of: determining a machine learning algorithm based on a training dataset; using the machine learning algorithm to build a machine learning model based on the training dataset; creating an executable file corresponding to the machine learning model, the executable file containing programming information for a programmable circuit; and loading the executable file into the programmable circuit so as to program the programmable circuit to allow the programmable circuit to use the machine learning model to process data.

### CROSS-REFERENCE TO RELATED APPLICATION

This application claims priority of Taiwanese Invention Patent Application No. 108130654, filed on Aug. 27, 2019.

### FIELD

The disclosure relates to a method for machine learning deployment, and more particularly to a method for machine learning deployment that can automatically determine a machine learning algorithm.

### BACKGROUND

As machine learning technology is progressively deployed in multiple fields such as the medical field, the economic field, the industrial field, and so on, a number of software companies have developed artificial intelligence (AI) platforms for the purpose of facilitating interested enterprises to build machine learning applications according to their own demands. Some hardware companies have also developed AI accelerator chips and/or embedded AI-facilitating devices, in order to increase performance of the machine learning applications built by these enterprises.

### SUMMARY

An object of the disclosure is to provide a method for machine learning deployment that improves performance of machine learning applications and enhances user convenience.

According to one aspect of the disclosure, the method includes steps of: by a processing device, determining a machine learning algorithm based on a training dataset; and by the processing device, using the machine learning algorithm to build a machine learning model based on the training dataset.

According to one aspect of the disclosure, the method further includes steps of: by the processing device, creating an executable file corresponding to the machine learning model, the executable file containing programming information for a programmable circuit; by the processing device, loading the executable file into the programmable circuit so as to program the programmable circuit to allow the programmable circuit to use the machine learning model to process data; and by a processing unit electrically connected to the programmable circuit, transmitting to-be-analyzed data to the programmable circuit running the executable file, so that the programmable circuit uses the machine learning model to analyze the to-be-analyzed data to thereby obtain an inference result.

### BRIEF DESCRIPTION OF THE DRAWINGS

Other features and advantages of the disclosure will become apparent in the following detailed description of the embodiment (s) with reference to the accompanying drawings, of which:

FIG. 1 exemplarily illustrates a system for providing machine learning service according to an embodiment of the disclosure;

FIG. 2 is a flow chart exemplarily illustrating a method for machine learning deployment according to an embodiment of the disclosure; and

FIG. 3 is a flow chart exemplarily illustrating sub-steps of a step of determining a machine learning algorithm of the method of FIG. 2 according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

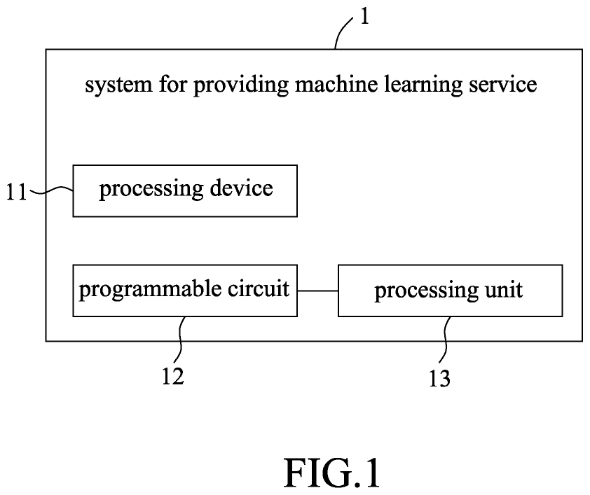

FIG. 1 exemplarily illustrates a system 1 for providing machine learning service according to an embodiment of the disclosure. The system 1 includes a processing device 11, a programmable circuit 12, and a processing unit 13 electrically connected to the programmable circuit 12. According to some embodiments, the processing device 11 may be, for example, a personal computer (PC), a server, a laptop computer or a tablet computer, but the disclosure is not limited thereto. According to some embodiments, the programmable circuit 12 may be, but not limited to, an integrated circuit, such as a field programmable gate array (FPGA) that can be quickly programmed and reconfigured. According to some embodiments, the processing unit 13 may include, but not limited to, a central processing unit (CPU), a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. In some embodiments, the processing device 11 and the processing unit 13 are of a same device. For example, the processing unit 13 may be a processing unit (e.g., CPU) of the processing device 11. In other embodiments, the processing unit 13 is external to the processing device 11 and is able to communicate with the processing device 11 via wired communication through a computer cable or via wireless communication using a wireless technology (e.g., Bluetooth®, Wi-Fi, etc.).

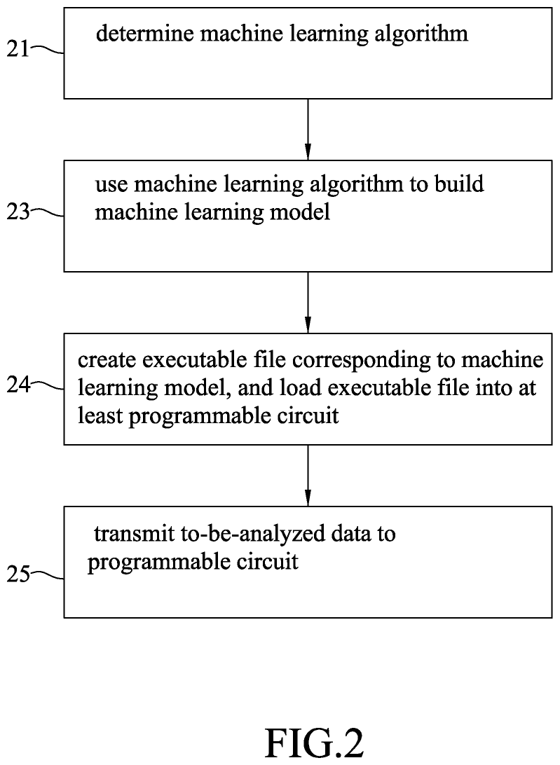

FIG. 2 exemplarily illustrates a method for machine learning deployment according to an embodiment of the disclosure. The method can be implemented by the system. 1 shown in FIG. 1, and includes steps 21-25 that are described below with reference to the system 1 of FIG. 1.

In step 21, the processing device 11 determines, based on a training dataset, a machine learning algorithm applicable to the training dataset in order to build a corresponding machine learning model. According to some embodiments, the machine learning algorithm thus determined is selected from among a neural algorithm, a support vector machine (SVM) algorithm and a k-means algorithm. The training dataset contains plural pieces of training data each having an input feature. According to some embodiments, each piece of training data may optionally further have a label that indicates a desired output corresponding to the input feature thereof. The plural pieces of training data include plural pieces of establishment data and plural pieces of verification data; that is to say, a portion of the plural pieces of training data are establishment data and the rest are verification data.

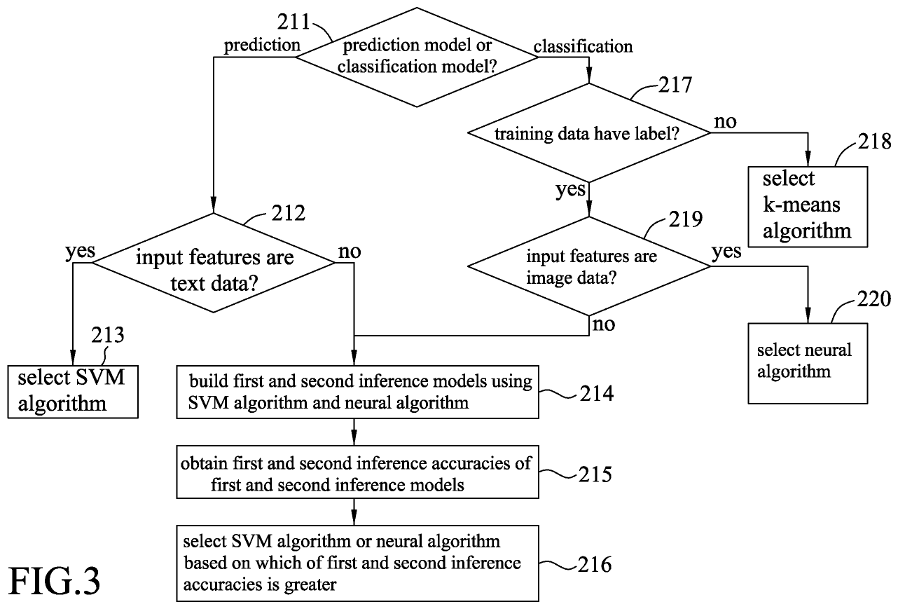

Step 21 includes sub-steps 211 to 220 illustrated in FIG. 3. Referring to FIG. 3, in sub-step 211, the processing device 11 determines whether the machine learning model to be built is a prediction model or a classification model based on the training dataset. When it is determined that the machine learning model to be built is a prediction model, the procedure goes to sub-step 212; when it is determined that the machine learning model to be built is a classification model, the procedure goes to sub-step 217. According to some embodiments, the determination as to whether the machine learning model to be built is a prediction model or a classification model is made based on whether the establishment data contained in the training dataset has labels and based on what type of labels the training dataset has. For example, in an embodiment, the processing device 11 determines that the machine learning model to be built is a prediction model when each piece of establishment data has a label which is a mathematical value, and determines that the machine learning model to be built is a classification model when each piece of establishment data has no label or has a label indicating a classification.

In sub-step 212, the processing device 11 determines whether the input features in the training dataset are each in the form of text data. If so, the procedure goes to sub-step 213; otherwise, the procedure goes to sub-step 214.

In sub-step 213, the processing device 11 selects the SVM algorithm to serve as the machine learning algorithm.

In sub-step 214, based on the plural pieces of establishment data in the training dataset, the processing device 11 uses the SVM algorithm and the neural algorithm to build a first inference model and a second inference model, respectively. According to some embodiments, software modules of the neural algorithm, the SVM algorithm and the k-means algorithm have been pre-installed in the processing device 11, so that the processing device 11 may build machine learning models by using the software modules. Therefore, the first inference model is built by using the software module of the SVM algorithm, and the second inference model is built by using the software module of the SVM algorithm.

In sub-step 215, the processing device 11 uses the plural pieces of verification data in the training dataset to test the first inference model and the second inference model to obtain a first inference accuracy and a second inference accuracy, respectively. According to some embodiments, the first inference accuracy is obtained by first, for each piece of verification data in the training dataset, obtaining a first inferred result corresponding to the piece of verification data by feeding the input feature of the piece of verification data into the first inference model, and determining whether the first inferred result thus obtained matches the label of the piece of verification data, and then determining the first inference accuracy based on a ratio of a number of those of the first inferred results that match the labels to a total number of the first inferred results corresponding respectively to the plural pieces of verification data. Similarly, the second inference accuracy is obtained by first, for each piece of verification data in the training dataset, obtaining a second inferred result corresponding to the piece of verification data by feeding the input feature of the piece of verification data into the second inference model, and determining whether the second inferred result thus obtained matches the label of the piece of verification data, and then determining the second inference accuracy based on a ratio of a number of those of the second inferred results that match the labels to a total number of the second inferred results corresponding respectively to the plural pieces of verification data.

In sub-step 216, the processing device 11 determines the machine learning algorithm based on which one of the first inference accuracy and the second inference accuracy is greater. Specifically, the processing device 11 selects the SVM algorithm to serve as the machine learning algorithm when it is determined that the first inference accuracy is greater, and selects the neural algorithm to serve as the machine learning algorithm when it is determined that the second inference accuracy is greater.

On the other hand, when it is determined in sub-step 211 that the machine learning model to be built is a classification model, the procedure goes to sub-step 217.

In sub-step 217, the processing device 11 determines whether the plural pieces of training data each have a label. If so, the procedure goes to sub-step 219; otherwise, the procedure goes to sub-step 218.

In sub-step 218, the processing device 11 selects the k-means algorithm to serve as the machine learning algorithm.

In sub-step 219, the processing device 11 determines whether the input features of the plural pieces of training data in the training dataset are each in the form of image data. If so, the procedure goes to sub-step 220; otherwise, the procedure goes to sub-steps 214-216.

In sub-step 220, the processing device 11 selects the neural algorithm to serve as the machine learning algorithm.

Referring back to FIG. 2, in step 23, the processing device 11 uses the machine learning algorithm determined in step 21 to build a machine learning model based on the training dataset. According to some embodiments, the processing device 11 uses each piece of training data contained in the training dataset and the software module corresponding to the determined machine learning algorithm to build the machine learning model.

In step 24, the processing device 11 creates an executable file corresponding to the machine learning model by using a software tool, and loads the executable file into the processing unit 13 and the programmable circuit 12 in order to program the programmable circuit 12 to allow the programmable circuit 12 to use the machine learning model to process data. According to some embodiments, the processing device 11 may create the executable file by executing a deep neural network development kit (DNNDK) to transform the machine learning model to an Executable and Linkable Format (ELF) file that includes a first instruction set to be executed on the processing unit 13, a second instruction set to be executed on the programmable circuit 12, and a set of register-transfer level (RTL) codes to be executed on the programmable circuit 12. Moreover, when the machine learning algorithm determined in step 21 is the SVM algorithm or the k-means algorithm, the processing device 11 may further execute, in step 24, Vivado® to transform the machine learning model to a bitstream file that is to be burned on the programmable circuit 12 to form an intellectual property (IP) core that can use the machine learning model (of the SVM algorithm or of the k-means algorithm) to process data. In these embodiments, if a bitstream file is generated in step 24, the second instruction set and the set of RTL codes of the ELF file generated by the DNNDK are to be executed on the programmable circuit 12 that has been programmed with the bitstream file; otherwise, the second instruction set and the set of RTL codes of the ELF file generated by the DNNDK are to be executed on a deep learning processing unit (DPU), such as a Xilinx DPU, of the programmable circuit 12 that is an IP core that utilizes hardware resources, including the lookup table (LUT), the register, the block random access memory (BRAM) and the digital signal processor (DSP), in the FPGA to increase computing speed of neural network computation.

In step 25, the processing unit 13 transmits to-be-analyzed data to the programmable circuit 12 running the executable file, in order for the programmable circuit 12 to use the machine learning model to analyze the to-be-analyzed data to obtain an inference result. According to some embodiments, when receiving an instruction to analyze data with the machine learning model built in step 23, the processing unit 13 executes the first instruction set and sends the to-be-analyzed data to an IP core (which may be a DPU or an IP core formed with a bitstream file generated by Vivado®) of the programmable circuit 12 to request the IP core to analyze the to-be-analyzed data (i.e., make a reference with the to-be-analyzed data) with the machine learning model and to send the inference result back to the processing unit 13.

It can be appreciated that the disclosed method for machine learning deployment which automatically determines a best machine learning algorithm that is not only a suitable algorithm to the training dataset but also an algorithm with higher inference accuracy is advantageous. Further, the disclosed method is beneficial in utilizing software tools and the programmable circuit 12 to allow users to easily create customized hardware with acceleration functionality for executing the established machine learning model.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for machine learning deployment, comprising steps of:
by a processing device, determining a machine learning algorithm based on a training dataset; and
by the processing device, using the machine learning algorithm to build a machine learning model based on the training dataset.

2. The method of claim 1, further comprising steps of:
by the processing device, creating an executable file corresponding to the machine learning model, the executable file containing programming information for a programmable circuit;
by the processing device, loading the executable file into the programmable circuit so as to program the programmable circuit to allow the programmable circuit to use the machine learning model to process data; and
by a processing unit electrically connected to the programmable circuit, transmitting to-be-analyzed data to the programmable circuit running the executable file, so that the programmable circuit uses the machine learning model to analyze the to-be-analyzed data to thereby obtain an inference result.

3. The method of claim 2, wherein the step of creating an executable file is to execute a deep neural network development kit (DNNDK) to create the executable file.

4. The method of claim 3, wherein the step of creating an executable file is to further execute Vivado® to create a bitstream file to be burned on the programmable circuit when the machine learning algorithm determined in the step of determining a machine learning algorithm is one of a support vector machine (SVM) algorithm and a k-means algorithm.

5. The method of claim 1, wherein the training dataset contains plural pieces of training data each having an input feature, and the step of determining a machine learning algorithm includes sub-steps of:
determining whether the machine learning model to be built is a prediction model or a classification model based on the training dataset;
when it is determined that the machine learning model to be built is a prediction model, determining whether the input features in the training dataset are each in the form of text data; and
when it is determined that the input features are each in the form of text data, selecting a support vector machine (SVM) algorithm to serve as the machine learning algorithm.

6. The method of claim 5, wherein the plural pieces of training data include plural pieces of establishment data and plural pieces of verification data, and the step of determining a machine learning algorithm further includes sub-steps of:
when it is determined that the input features are not in the form of text data,
based on the plural pieces of establishment data in the training dataset, using the SVM algorithm and a neural algorithm to build a first inference model and a second inference model, respectively,
using the plural pieces of verification data in the training dataset to test the first inference model and the second inference model to thereby obtain a first inference accuracy and a second inference accuracy, respectively, and
determining which one of the first inference accuracy and the second inference accuracy is greater;
when it is determined that the first inference accuracy is greater, selecting the SVM algorithm to serve as the machine learning algorithm; and
when it is determined that the second inference accuracy is greater, selecting the neural algorithm to serve as the machine learning algorithm.

7. The method of claim 6, wherein each piece of verification data in the training dataset has a label corresponding to the input feature of the piece of verification data, and wherein the sub-step of using the plural pieces of verification data to obtain a first inference accuracy and a second inference accuracy includes:
for each piece of verification data in the training dataset,
obtaining a first inferred result corresponding to the piece of verification data by feeding the input feature of the piece of verification data into the first inference model,
determining whether the first inferred result thus obtained matches the label of the piece of verification data,
obtaining a second inferred result corresponding to the piece of verification data by feeding the input feature of the piece of verification data into the second inference model, and
determining whether the second inferred result thus obtained matches the label of the piece of verification data;
determining the first inference accuracy based on a ratio of a number of those of the first inferred results that match the labels to a total number of the first inferred results; and
determining the second inference accuracy based on a ratio of a number of those of the second inferred results that match the labels to a total number of the second inferred results.

8. The method of claim 5, wherein the step of determining a machine learning algorithm further includes sub-steps of:
when it is determined that the machine learning model to be built is a classification model, determining whether the plural pieces of training data each have a label; and
when it is determined that the plural pieces of training data each do not have a label, selecting a k-means algorithm to serve as the machine learning algorithm.

9. The method of claim 8, wherein the step of determining a machine learning algorithm further includes sub-steps of:
when it is determined that the plural pieces of training data each have a label, determining whether the input features of the plural pieces of training data in the training dataset are each in the form of image data; and
when it is determined that the input features are each in the form of image data, selecting a neural algorithm to serve as the machine learning algorithm.

10. The method of claim 9, wherein the plural pieces of training data include plural pieces of establishment data and plural pieces of verification data, and the step of determining a machine learning algorithm further includes sub-steps of:
when it is determined that the input features are not in the form of image data,
using the SVM algorithm and the neural algorithm to build a first inference model and a second inference model based on the plural pieces of establishment data in the training dataset, respectively,
using the plural pieces of verification data in the training dataset to test the first inference model and the second inference model to thereby obtain a first inference accuracy and a second inference accuracy, respectively, and
determining which one of the first inference accuracy and the second inference accuracy is greater;
when it is determined that the first inference accuracy is greater, selecting the SVM algorithm to serve as the machine learning algorithm; and
when it is determined that the second inference accuracy is greater, selecting the neural algorithm to serve as the machine learning algorithm.
